(19) United States
(12) Patent Application Publication
(10) Pub. No.: US 2008/0254365 A1
(43) Pub. Date: Oct. 16, 2008

(54) NEGATIVE ACTIVE MATERIAL FOR RECHARGEABLE LITHIUM BATTERY, METHOD OF PREPARING SAME, AND RECHARGEABLE LITHIUM BATTERY INCLUDING SAME

(76) Inventors: Tae-Wan Kim, Suwon-si (KR); Joon-Sup Kim, Suwon-si (KR); Sung-Soo Kim, Suwon-si (KR); Ri-Zhu Yin, Suwon-si (KR); Jin-Ho Lee, Suwon-si (KR); Wan-Uk Choi, Suwon-si (KR)

Correspondence Address: CHRISTIE, PARKER & HALE, LLP, PO BOX 7068, PASADENA, CA, 91109-7068, US

(21) Appl. No.: 11/947,708

(22) Filed: Nov. 29, 2007

(30) Foreign Application Priority Data
Apr. 13, 2007 (KR) 10-2007-0036561

(51) Int. Cl. H01M 4/52; H01M 4/50; H01M 4/58

(52) U.S. Cl. 429/221; 429/224; 429/231.5

(57) ABSTRACT

Negative active materials for rechargeable lithium batteries, manufacturing methods thereof, and rechargeable lithium batteries including the negative active materials are provided. The negative active material includes a compound represented by the Formula Li₁₊ₓV_{1-x-y}M_{y}O_{2+z}. In one embodiment, the compound has an average particle size ranging from about 50 nm to about 30 μm. In another embodiment, the negative active material has a ratio of (003) plane diffraction intensity to (104) plane diffraction intensity ranging from about 1:1 to about 1:0.01 when measured using a Cu K α X-ray. According to another embodiment, after five charge/discharge cycles performed at 0.5C, a specific surface area of the negative active material increases to less than about 20 times a specific surface area before the five charge/discharge cycles. The negative active materials may improve battery capacity, and cycle-life characteristics.

### CROSS-REFERENCE TO RELATED APPLICATION

This application claims priority to and the benefit of Korean Patent Application No. 10-2007-0036561 filed in the Korean Intellectual Property Office on Apr. 13, 2007, the entire content of which is incorporated herein by reference.

### BACKGROUND OF THE INVENTION

1. Field of the Invention

The present invention relates to negative active materials for rechargeable lithium batteries, to methods of preparing the same, and to rechargeable lithium batteries including the same.

2. Description of the Related Art

Lithium rechargeable batteries have recently drawn attention as power sources for small and portable electronic devices. These batteries use organic electrolyte solutions and thereby have discharge voltages twice as high as conventional batteries using alkaline aqueous solutions. Accordingly, lithium rechargeable batteries have high energy densities.

Lithium-transition element composite oxides capable of intercalating lithium, such as LiCoO₂, LiMn₂O₄, LiNiO₂, LiNi₁₋ₓCoₓO₂ (0<x<1), LiMnO₂, and so on, have been researched for use as positive active materials in lithium rechargeable batteries.

Various carbon-based materials, such as artificial and natural graphite, and hard carbon, which all can intercalate and deintercalate lithium ions have been used as negative active materials. Of the carbon-based materials, graphite increases battery discharge voltage and energy density because it has a low discharge potential of −0.2V compared to lithium. Batteries using graphite as the negative active material have high average discharge potentials of 3.6V and excellent energy densities. Furthermore, among the aforementioned carbon-based materials, graphite is the most comprehensively used since graphite guarantees better battery cycle life due to its outstanding reversibility. However, when used as a negative active material, graphite active materials have low densities and consequently low capacities (theoretical capacity: 2.2 g/cc) in terms of energy density per unit volume. Further, there is some danger of explosion, combustion or the like when the battery is misused or overcharged, because graphite is likely to react with the organic electrolyte at high discharge voltages.

To address these concerns, research has recently been conducted into oxide negative electrodes. For example, amorphous tin oxide has a high capacity per weight (800 mAh/g). However, this oxide has resulted in some critical defects such as a high initial irreversible capacity of up to 50%. Furthermore, its discharge potential is more than 0.5V, and it shows a smooth voltage profile, which is unique in the amorphous phase. Consequently, it has been difficult to prepare a tin oxide that is applicable in batteries. Furthermore, a part of the tin oxide has tended reduce into tin metal during charge or discharge reactions, which exacerbates its acceptance for use in batteries.

In another oxide negative electrode, LiₐMg_{b}VO_{c} (where 0.05≦a≦3, 0.12≦b≦2, and 2≦2c-a-2b≦5) is used as the negative active material. Another lithium secondary battery includes a Li_{1.1}V_{0.9}O₂ negative active material. However, such oxide negative electrodes do not impart sufficient battery performance and therefore further research into oxide negative materials has been conducted.

### SUMMARY OF THE INVENTION

One embodiment of the present invention provides a negative active material for a rechargeable lithium battery that may improve battery capacity and cycle-life characteristics.

Another embodiment of the present invention provides a method of preparing a negative active material that may economically produce a negative active material for a rechargeable lithium battery.

Yet another embodiment of the present invention provides a lithium electrolyte rechargeable battery including the negative active material.

According to one embodiment of the present invention, a negative active material for a rechargeable lithium battery includes a compound having the following Formula 1 and having an average particle size ranging from about 50 nm to about 30 μm.

Li₁₊ₓV_{1-x-y}M_{y}O_{2+z} Formula 1

In Formula 1, 0.01≦x≦0.5, 0<y≦0.3, −0.2≦z≦0.2, and M is selected from transition elements, alkali metals, alkaline earth metals, semi-metals, and combinations thereof. According to one embodiment, M is selected from Fe, Al, Cr, Mo, Ti, W, Zr, Sr, Mn, and combinations thereof.

In one embodiment, the negative active material has an average particle size ranging from about 0.5 μm to about 20 μm.

In another embodiment, the negative active material has a ratio of (003) plane diffraction intensity to (104) plane diffraction intensity ranging from about 1:0.01 to about 1 when measured using a Cu K α X-ray. According to one embodiment, the negative active material has a ratio of (003) plane diffraction intensity to (104) plane diffraction intensity ranging from about 1:0.1 to about 1.

After charge/discharge at 0.5 C five times, the specific surface area of the negative active material according to an embodiment of the present invention may increase to less than about 20 times the specific surface area before charge and discharge. In another embodiment, after charge/discharge at 0.5 C five times, the specific surface area of the negative active material may increase to about 2 to about 20 times the specific surface area before charge and discharge.

According to another embodiment of the present invention, a method for manufacturing a negative active material for a rechargeable lithium battery includes preparing an intermediate product by mixing a lithium source material and a vanadium source material in a mixed solvent of an acid and water, and drying the intermediate product or performing heat decomposition. Heat decomposition may be performed at a temperature ranging from about 70 to about 400° C.

Another source material, M, may be added to the mixture of the lithium source material and the vanadium source material. A calcination process may be further performed after the drying or heat decomposition. The calcination process may be performed at a temperature ranging from about 700 to about 1300° C.

The lithium source material may be an acid soluble or water soluble compound selected from Li₂C₂O₄, LiOH, LiNO₃, Li₂SO₄, hydrates of LiOH, hydrates of LiNO₃, hydrates of Li₂SO₄, and combinations thereof.

The vanadium source material may be a water insoluble compound selected from V₂O₃, V₂O₄, V₂O₅, NH₄VO₃, and combinations thereof.

The acid may be a weak acid having at least one carboxyl group. Nonlimiting examples of the acid include carboxylic acid, oxalic acid, citric acid, and combinations thereof.

According to another embodiment of the present invention, a rechargeable lithium battery includes a negative electrode including the negative active material, a positive electrode including a positive active material that is capable of reversibly intercalating and deintercalating lithium ions, and an electrolyte.

### BRIEF DESCRIPTION OF THE DRAWINGS

The above and other features and advantages of the present invention will be better understood with reference to the following detailed description when considered in conjunction with the attached drawings, in which:

FIG. 1 is a schematic cross-sectional view of a rechargeable lithium battery according to one embodiment of the present invention; and

FIG. 2 is a graph comparing the cycle-life characteristics of battery cells prepared according to Example 1 and Comparative Example 1.

### DETAILED DESCRIPTION OF THE INVENTION

A negative active material for a rechargeable lithium battery according to one embodiment of the present invention includes a compound represented by the following Formula 1.

Li₁₊ₓV_{1-x-y}M_{y}O_{2+z} Formula 1

In Formula 1, 0.01≦x≦0.5, 0<y≦0.3, −0.2≦z≦0.2, and M is selected from transition elements, alkali metals, alkaline earth metals, semi-metals, and combinations thereof. According to one embodiment, M is selected from Fe, Al, Cr, Mo, Ti, W, Zr, Sr, Mn, and combinations thereof.

In one embodiment, the negative active material has an average particle size ranging from about 50 nm to about 30 μm. According to one embodiment, the negative active material has an average particle size ranging from about 0.5 μm to about 20 μm. When the average particle size of the negative active material is less than about 50 nm, a large amount of solvent should be used to prepare a composition for the negative active material for preparation of the electrode, thus making it difficult to prepare the electrode. When the average particle size of the negative active material is more than about 30 μm, efficiency deteriorates, which is undesirable.

According to another embodiment, the negative active material has a ratio of (003) plane diffraction intensity to (104) plane diffraction intensity ranging from about 1:0.01 to about 1 when measured using a Cu K α X-ray. According to one embodiment, the negative active material has a ratio of (003) plane diffraction intensity to (104) plane diffraction intensity ranging from about 1:0.1 to about 1. When the ratio of (003) plane diffraction intensity to (104) plane diffraction intensity is out of this range, crystalline properties deteriorate, resulting in a decreased amount that reacts with lithium, which is undesirable.

The specific surface area of the negative active changes very little, because no cracks occur after charge and discharge. In one embodiment, for example, after five charge/discharge cycles at 0.5 C, the specific surface area of the negative active material of the present invention increases to less than 20 times the specific surface area before the charge/discharge cycles. In another embodiment, after five charge/discharge cycles at 0.5 C, the specific surface area of the negative active material of the present invention increases to from about 2 to about 20 times the specific surface area before the charge/discharge cycles. The specific surface area of the negative active materials according to the present invention increase to a lesser extent than the specific surface area of negative active materials prepared according to conventional solid-phase methods, which increase to 30 to 50 times the starting surface area. Therefore, the negative active materials of the present invention may prevent capacity reductions caused by repeated charge/discharge cycles, thereby improving cycle-life characteristics.

According to another embodiment of the present invention, the negative active materials having the aforementioned physical properties may be prepared according to the following method.

First, a lithium source material and a vanadium source material are mixed in a mixed solvent of an acid and water. A M source material may also be added to the mixture, depending on the desired end product.

The lithium source material may be an acid soluble or water soluble compound selected from Li₂C₂O₄, LiOH, LiNO₃, Li₂SO₄, hydrates of LiOH, hydrates of LiNO₃, hydrates of Li₂SO₄, and combinations thereof.

The vanadium source material may be a water insoluble compound selected from V₂O₃, V₂O₄, V₂O₅, NH₄VO₃, and combinations thereof. According to one embodiment, V₂O₅ may be as the vanadium source material. According to a conventional solid-phase method, the lithium source material and the vanadium source material would be mixed in a solid-phase through milling, and calcinated under a nitrogen atmosphere. However, as economical materials such as V₂O₅ cannot be used in such a method, production cost is high.

The mixing ratio of the lithium source material, the vanadium source material, and if necessary, the M source material may be properly adjusted such that the negative active material according to Formula 1 is acquired.

The M source material is a compound selected from transition elements, alkali metals, alkaline earth metals, semi-metals and combinations thereof. The compound may include oxides, nitrides, hydroxides and combinations thereof.

The acid may be a weak acid having at least one carboxyl group that may dissolve the lithium source material, reduce the vanadium source material, and chelate the dissolved lithium source material and reduced vanadium source material. The acid may be selected from carboxylic acid, oxalic acid, citric acid and combinations thereof.

A volume mixing ratio of the acid to water in the mixed solvent of the acid and water may range from about 0.5 to about 5:about 9.5 to about 5. Since the acid chelates the dissolved lithium source material and the reduced vanadium source material, when the amount of the acid is less than about 0.5 volume ratio, the lithium source material may remain undissolved. Thus, some vanadium source material remains. When the amount of the acid is more than about 5 volume ratio, the carbon component of the acid may remain in the subsequent calcination process, which is undesirable.

The mixing process produces an intermediate product. The intermediate product includes sites which easily decompose by heat so that heat decomposition may occur even at low temperatures.

A dried product is obtained by drying the intermediate product. In the drying process, the solvent is volatilized, and a salt including lithium, vanadium and, optionally, M is formed and precipitated. The kind of salt differs according to the kind of acid used. For example, when oxalic acid is used, an oxalate salt may be formed. The drying process may be performed at a temperature ranging from about 70 to about 400° C. The solvent is dried and volatilized in the drying process. When the drying process is performed at a temperature lower than about 70° C., the solvent is not dried. When it is performed at a temperature greater than about 400° C., the intermediate product is decomposed, which is undesirable.

Subsequently, the dried product is calcinated. The salt is decomposed during calcination, thereby producing the negative active material of the present invention. The calcination may be carried out at a temperature ranging from about 700 to about 1300° C. The calcination may be performed at a temperature lower than conventional calcination temperatures, which range from 1300 to about 1500° C. Therefore, it is possible to prevent lithium from volatilizing, to prevent vanadium from overly oxidizing, and to prepare a negative active material having high crystallinity.

In an alternative embodiment, instead of performing the drying process, the negative active material may be prepared by heating and decomposing the intermediate product. The drying and calcination may be simultaneously performed in the heat decomposition process. The salt is decomposed in the heat decomposition process. The heat decomposition may be carried out at a temperature ranging from about 400 to about 700° C. Also, a calcination process may be additionally performed after the heat decomposition process. The calcination may be performed at a temperature ranging from about 700 to about 1300° C.

The negative active material prepared according to an embodiment of the present invention may be used for a rechargeable lithium battery. Rechargeable lithium batteries may be classified into lithium ion batteries, lithium ion polymer batteries, and lithium polymer batteries according to the presence of a separator and the kind of electrolyte used in the battery. Rechargeable lithium batteries may be formed of a variety of shapes and sizes, including cylindrical, prismatic, and coin-type batteries. They may be thin film batteries or be rather bulky in size. Structures and fabricating methods for lithium ion batteries pertaining to the present invention are well known in the art.

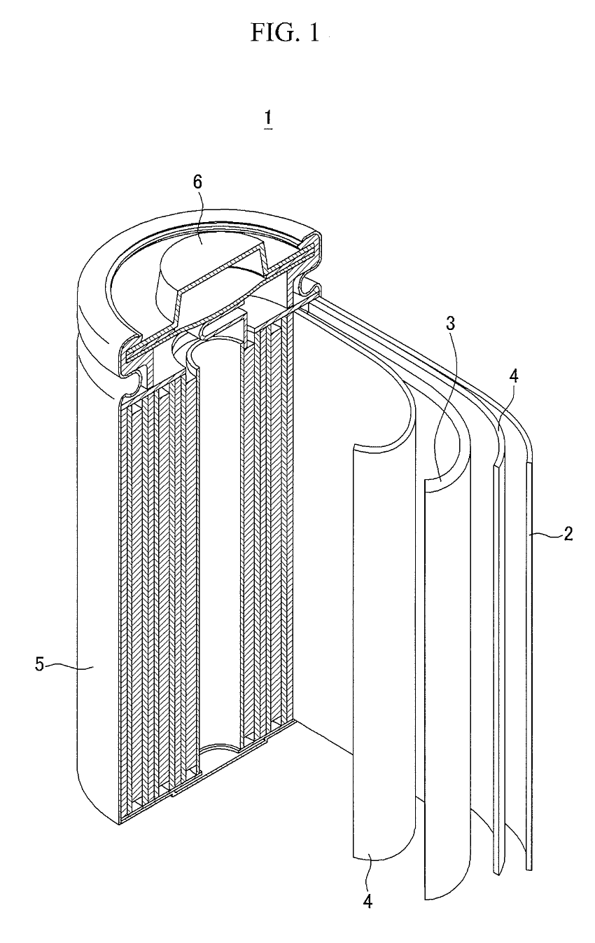

FIG. 1 is a schematic cross-sectional view of a rechargeable lithium battery according to one embodiment of the present invention. Referring to FIG. 1, the rechargeable lithium battery 1 includes an electrode assembly including a negative electrode 2, a positive electrode 3, and a separator 4 between the negative electrode 2 and the positive electrode 3. The electrode assembly is placed in a battery case 5 and sealed with a sealing member 6. The battery is completed by injecting an electrolyte into the sealed battery case to immerse the electrode assembly in the electrolyte.

The rechargeable lithium battery includes a negative electrode including the above negative active material, a positive electrode including a positive active material, and a non-aqueous electrolyte.

The negative electrode includes the negative active material, a binder, and optionally a conductive agent.

The binder acts to bind negative active material particles with each other and also to bind negative active material particles with the current collector. Nonlimiting examples of suitable binders include polyvinylalcohol, carboxymethylcellulose, hydroxypropylenecellulose, diacetylenecellulose, polyvinylchloride, polyvinylpyrrolidone, polytetrafluoroethylene, polyvinylidene fluoride, polyethylene, and polypropylene.

Any electrically conductive material may be used as the conductive agent, so long as it does not cause any chemical change. Nonlimiting examples of suitable conductive agents include natural graphite, artificial graphite, carbon black, acetylene black, ketjen black, carbon fiber, polyphenylene derivatives, metal powders or metal fibers including copper, nickel, aluminum, silver, and so on, and combinations thereof.

The negative electrode also includes a current collector that supports the negative active material layer including the negative active material, binder, and optional conductive agent. The current collector may be selected from copper foils, nickel foils, stainless steel foils, titanium foils, nickel foams, copper foams, polymer substrates coated with conductive metals, and combinations thereof.

The positive active material of the positive electrode includes a lithiated intercalation compound that is capable of reversibly intercalating and deintercalating lithium. The positive active material includes a composite oxide including lithium and a metal selected from cobalt, manganese, nickel, and combinations thereof. Nonlimiting examples of suitable positive active materials include those represented the following Formulas 2 to 25.

LiₐA_{1-b}B_{b}D₂ Formula 2

In Formula 2, 0.95≦a≦1.1 and 0≦b≦0.5.

LiₐE_{1-b}B_{b}O_{2-c}F_{c} Formula 3

In Formula 3, 0.95≦a≦1.1, 0≦b≦0.5, and 0≦c≦0.05.

LiE_{2-b}B_{b}O_{4-c}F_{c} Formula 4

In Formula 4, 0≦b≦0.5, and 0≦c≦0.05.

LiₐNi_{1-b-c}Co_{b}B_{c}D_{α} Formula 5

In Formula 5, 0.95≦a≦1.1, 0≦b≦0.5, 0≦c≦0.05, and 0<α≦2.

LiₐNi_{1-b-c}Co_{b}B_{c}O_{2-α}F_{α} Formula 6

In Formula 6, 0.95≦a≦1.1, 0≦b≦0.5, 0≦c≦0.05, and 0<α<2.

LiₐNi_{1-b-c}Co_{b}B_{c}O_{2-α}F₂ Formula 7

In Formula 7, 0.95≦a≦1.1, 0≦b≦0.5, 0≦c≦0.05, and 0<α<2.

LiₐNi_{1-b-c}Mn_{b}B_{c}D_{α} Formula 8

In Formula 8, 0.95≦a≦1.1, 0≦b≦0.5, 0≦c≦0.05, and 0<α≦2.

LiₐNi_{1-b-c}Mn_{b}B_{c}O_{2-α}F_{α} Formula 9

In Formula 9, 0.95≦a≦1.1, 0≦b≦0.5, 0≦c≦0.05, and 0<α<2.

LiₐNi_{1-b-c}Mn_{b}B_{c}O_{2-α}F₂ Formula 10

In Formula 10, 0.95≦a≦1.1, 0≦b≦0.5, 0≦c≦0.05, and 0<α<2.

LiₐNi_{b}E_{c}G_{d}O₂ Formula 11

In Formula 11, 0.90≦a≦1.1, 0≦b≦0.9, 0≦c≦0.5, and 0.001≦d≦0.1.

LiₐNi_{b}Co_{c}Mn_{d}GeO₂ Formula 12

In Formula 12, 0.90≦a≦1.1, 0≦b≦0.9, 0≦c≦0.5, 0≦d≦0.5, and 0.001≦e≦0.1.

LiₐNiG_{b}O₂ Formula 13

In Formula 13, 0.90≦a≦1.1, and 0.001≦b≦0.1.

LiₐCoG_{b}O₂ Formula 14

In Formula 14, 0.90≦a≦1.1, and 0.001≦b≦0.1.

LiₐMnG_{b}O₂ Formula 15

In Formula 15, 0.90≦a≦1.1, and 0.001≦b≦0.1.

LiₐMn₂G_{b}O₄ Formula 16

In Formula 16, 0.90≦a≦1.1, and 0.001≦b≦0.1.

QO₂ Formula 17

QS₂ Formula 18

LiQS₂ Formula 19

V₂O₅ Formula 20

LiV₂O₅ Formula 21

LiIO₂ Formula 22

LiNiVO₄ Formula 23

Li_{3-f}J₂(PO₄)₃ Formula 24

In Formula 24, 0≦f≦3.

Li_{3-f}Fe₂(PO₄)₃ Formula 25

In Formula 25, 0≦f≦2.

In the above Formulas 2 to 25, A is selected from Ni, Co, Mn, and combinations thereof. B is selected from Al, Ni, Co, Mn, Cr, Fe, Mg, Sr, V, rare earth elements, and combinations thereof. D is selected from O, F, S, P, and combinations thereof. E is selected from Co, Mn, and combinations thereof. F is selected from F, S, P, and combinations thereof. G is a transition element or lanthanide element selected from Al, Cr, Mn, Fe, Mg, La, Ce, Sr, V, and combinations thereof. Q is selected from Ti, Mo, Mn, and combinations thereof. I is selected from Cr, V, Fe, Sc, Y, and combinations thereof. J is selected from V, Cr, Mn, Co, Ni, Cu, and combinations thereof.

The positive electrode further includes a binder and a conductive agent. The binder and conductive agent are the same as in the negative electrode, described above. The positive electrode also includes a current collector. One nonlimiting example of a suitable current collector is aluminum foil.

The negative and positive electrodes may be fabricated as follows. An active material composition including the active material, a binder, and optionally a conductive agent are mixed in a solvent and the mixture is applied on a current collector, such as aluminum. This electrode manufacturing method is well known, and thus is not described in detail in the present specification. For the solvent, any solvent used for battery fabrication may be used. One nonlimiting example of a suitable solvent is N-methylpyrrolidone.

In the above rechargeable lithium battery, the non-aqueous electrolyte includes a non-aqueous organic solvent and a lithium salt. The non-aqueous organic solvent acts as a medium for transmitting ions taking part in the electrochemical reaction of the battery. The non-aqueous organic solvent may include a carbonate-based, ester-based, ether-based, ketone-based, alcohol-based, or aprotic solvent. Nonlimiting examples of suitable carbonate-based solvents include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and so on. Nonlimiting examples of suitable ester-based solvents include n-methyl acetate, n-ethyl acetate, n-propyl acetate, dimethylacetate, methylpropionate, ethylpropionate, γ-butyrolactone, decanolide, valerolactone, mevalonolactone, caprolactone, and so on. Nonlimiting examples of suitable ether-based solvents include dibutyl ether, tetraglyme, diglyme, dimethoxyethane, 2-methyltetrahydrofuran, tetrahydrofuran, and so on. Nonlimiting examples of suitable ketone-based solvents include cyclohexanone, and so on. Nonlimiting examples of suitable alcohol-based solvents include ethyl alcohol, isopropyl alcohol, and so on. Nonlimiting examples of suitable aprotic solvents include nitriles such as X—CN (where X is a C2 to C20 linear, branched, or cyclic hydrocarbon, a double bond, an aromatic ring, or an ether bond), amides such as dimethylformamide, dioxolanes such as 1,3-dioxolane, sulfolanes, and so on.

The non-aqueous organic solvent may include a single solvent or a mixture of solvents. When the organic solvent includes a mixture, the mixture ratio may be controlled in accordance with the desired battery performance.

In one embodiment, a carbonate-based solvent may include a mixture of a cyclic carbonate and a linear carbonate. The cyclic carbonate and the linear carbonate may be mixed together in a volume ratio ranging from about 1:1 to about 1:9. When such a mixture is used as the electrolyte, electrolyte performance may be enhanced.

In addition, the electrolyte according to one embodiment of the present invention may further include mixtures of carbonate-based solvents and aromatic hydrocarbon-based solvents. The carbonate-based solvents and the aromatic hydrocarbon-based solvents may be mixed together in a volume ratio ranging from about 1:1 to about 30:1.

In one embodiment, the aromatic hydrocarbon-based organic solvent may be represented by the following Formula 26.

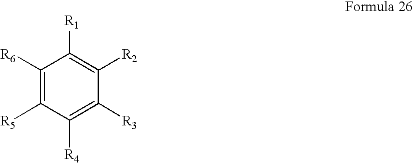

In Formula 26, R₁ through R₆ are each independently selected from hydrogen, halogens, C1 to C10 alkyls, C1 to C10 haloalkyls, and combinations thereof.

Nonlimiting examples of suitable aromatic hydrocarbon-based organic solvents include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and combinations thereof.

The non-aqueous electrolyte may further include an additive such as vinylene carbonate or fluoroethylene carbonate in order to improve battery cycle-life. The additive may be used in an appropriate amount for improving cycle-life.

The lithium salt is dissolved in the non-aqueous organic solvent to supply lithium ions in the battery. This enables the basic operation of the rechargeable lithium battery, and facilitates transmission of lithium ions between positive and negative electrodes. Nonlimiting examples of suitable lithium salts include supporting electrolyte salts such as LiPF₆, LiBF₄, LiSbF₆, LiAsF₆, LiCF₃SO₃, LiN(SO₂C₂F₅)₂, Li(CF₃SO₂)₂N, LiC₄F₉SO₃, LiClO₄, LiAlO₄, LiAlCl₄, LiN(CₓF₂ₓ₊₁SO₂)(C_{y}F_{2y+1}SO₂) (where x and y are natural numbers), LiCl, LiI, and lithium bisoxalate borate. The lithium salt may be present in a concentration ranging from about 0.1 to about 2.0M. When the lithium salt concentration is less than about 0.1M, electrolyte performance may deteriorate due to low electrolyte conductivity. When the lithium salt concentration is greater than about 2.0M, lithium ion mobility may be reduced due to an increase in electrolyte viscosity.

The electrolyte may be a solid electrolyte, such as a polyethylene oxide polymer electrolyte or a polymer electrolyte including at least one polyorganosiloxane side chain or polyoxyalkylene side chain. Alternatively, the electrolyte may be a sulfide electrolyte, such as Li₂S—SiS₂, Li₂S—GeS₂, Li₂S—P₂S₅, or Li₂S—B₂S₃. In another embodiment, the electrolyte may be an inorganic electrolyte such as Li₂S—SiS₂—Li₃PO₄ or Li₂S—SiS₂—Li₃SO₄.

The rechargeable lithium battery generally includes a positive electrode, a negative electrode, and an electrolyte. The battery may further include a separator as needed. The separator may include any material used in conventional lithium secondary batteries. Non-limiting examples of suitable separator materials include polyethylene, polypropylene, polyvinylidene fluoride, and multi-layers thereof, such as polyethylene/polypropylene double-layered separators, polyethylene/polypropylene/polyethylene triple-layered separators, and polypropylene/polyethylene/polypropylene triple-layered separators.

The following examples illustrate embodiments of the present invention. However, it is understood that these examples are presented for illustrative purposes only and do not limit the scope of the present invention.

### EXAMPLE 1

An intermediate product was prepared by mixing Li₂C₂O₄ and V₂O₃, Cr₂(SO₄)₃ in a mixed solvent of carboxylic acid and water, which solvent was mixed in a volume ratio of 5:5. Li₂C₂O₄ and V₂O₃ were mixed in a molar ratio of 1.1:0.89:0.01. The intermediate product was dried at 200° C. The solvent was volatilized and removed during drying, and a salt of lithium vanadium oxalate was produced and precipitated. The acquired product was decomposed at 700° C., and calcinated at 1000° C. to thereby prepare a Li_{1.1}V_{0.89}Cr_{0.01}O₂ negative active material. The average particle size of the negative active material ranged from 1 to 20 μm.

A negative active material slurry was prepared by mixing the negative active material with a polyvinylidene fluoride binder and a carbon black conductive material in a wt % ratio of 90:5:5 in an N-methylpyrrolidone solvent. The negative active material slurry was coated on foil, dried, and compressed to thereby prepare a negative electrode.

### EXAMPLE 2

A negative electrode was prepared as in Example 1, except that a Li_{1.2}V_{0.79} Cr_{0.01}O₂ negative active material was prepared by mixing Li₂C₂O₄ and V₂O₃, Cr₂(SO₄)₃ at a molar ratio of 1.2:0.79:0.01.

### EXAMPLE 3

A negative electrode was prepared as in Example 1, except that a Li_{1.3}V_{0.7}O₂ negative active material was prepared by mixing Li₂C₂O₄ and V₂O₃, Cr₂(SO₄)₃ at a molar ratio of 1.3:0.69:0.01.

### COMPARATIVE EXAMPLE 1

LiOH and V₂O₃ were mixed in a molar ratio of 1:0.5, and the mixture was pulverized. The powder product was calcinated at about 900° C., and screened with a sifter to thereby prepare a LiVO₂ negative active material. The average particle size of the prepared negative active material ranged from 5 to 20 μm. A negative electrode was prepared as in Example 1 except that this negative active material was used.

### COMPARATIVE EXAMPLE 2

A negative active material slurry was prepared by mixing a natural graphite negative active material with an average particle size of 18 μm with a polyvinylidene fluoride binder in a wt % ratio of 94:6 in an N-methylpyrrolidone solvent. The negative active material slurry was coated on copper foil to thereby prepare a negative electrode.

Rechargeable lithium battery cells were manufactured using the negative electrodes prepared according to Examples 1 through 3 and Comparative Examples 1 and 2 through a conventional manufacturing method. Then, initial discharge capacities and initial efficiencies of each battery were measured and the results are presented in the following Table 1. Also, each battery cell was charged and discharged at 0.5 C five times, and the specific surface area of each negative electrode was measured and compared with the initial specific surface area. The results are shown in the following Table 1. In addition, X-ray diffraction intensities were measured by CuK α X-ray, and the I(104)/I(003) diffraction intensity ratios are shown in the following Table 1.

TABLE 1

| | Initial | | Increase of | |
|---|---|---|---|---|
| | discharge | Initial | specific | |
| | capacity | efficiency | surface area | Intensity ratio |
| | (mAh/cc) | (%) | (5^{th} cycle/initial) | I(104)/I(003) |
| Example 1 | 605 | 86 | 2.5 times | 0.27 |
| Example 2 | 607 | 85 | 2.7 times | 0.26 |
| Example 3 | 604 | 85 | 3.0 times | 0.23 |
| Comparative | 50 | 30 | * | 0.1 |
| Example 1 | | | | |
| Comparative | 540 | 90 | * | * |
| Example 2 | | | | |

In Table 1, * denotes measurement impossibility

As shown in Table 1, the battery cells using negative electrodes prepared according to Example 1 to 3 had superior initial discharge capacity and initial efficiency compared to the cell using a negative electrode prepared according to Comparative Example 1. Also, it can be seen from Table 1 that the battery cells using the negative electrodes prepared according to Example 1 to 3 had superior initial discharge capacities to the cell using the negative electrode prepared according to Comparative Example 2. The initial efficiencies of Examples 1 through 3 deteriorated similarly to that of Comparative Example 2. The specific surface areas of the battery cells prepared according to Examples 1 through 3 increased between about 2.5 times to 3 times the initial surface area. In contrast, after five cycles, the specific surface area of the battery cell prepared according to Comparative Example 2 increased to such an extent that it could not be measured. Also, it turned out that the specific surface area of the battery cell prepared according to Comparative Example 1 increased to such an extent that it also could not be measured.

In addition, Comparative Example 1 has a I(104)/I(003) intensity ratio of 0.1 and a remarkably low initial discharge capacity compared to the initial discharge capacities of Examples 1 through 3 with intensity ratios between 0.24 and 0.26. Also, since the battery cell of Comparative Example 2 used natural graphite, no peaks appeared in I(104) and I(003). Therefore, the ratio could not be measured.

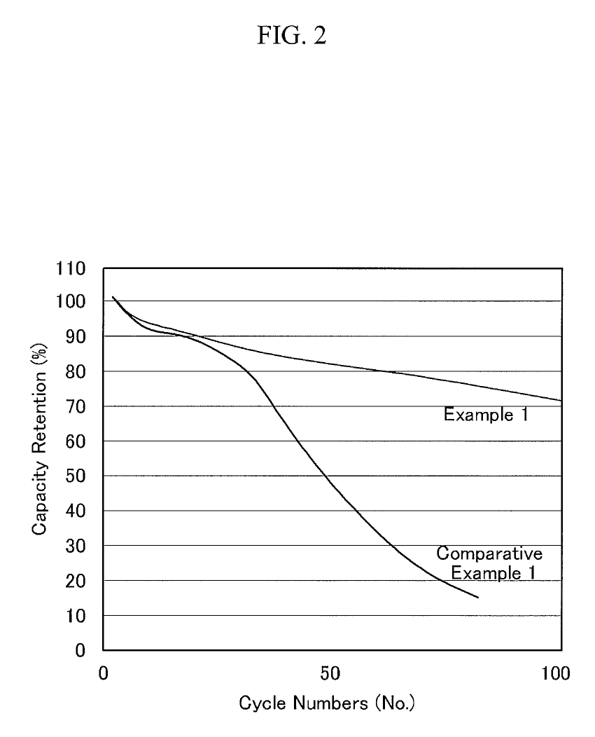

The battery cells prepared according to Example 1 and Comparative Example 1 were subjected to charge/discharge performed at 0.5 C, and capacity retention (i.e., cycle-life) of each cell was measured and the results are shown in FIG. 2. FIG. 2 is a graph comparing the capacity retention ratios (ratio of capacity after one charge/discharge cycle to capacity after repeated charge/discharge cycles) of the cell according to Example 1 and the cell according to Comparative Example 1. The capacity retention ratio is a relative value. The first value in the graph of FIG. 2 is the capacity after one charge/discharge cycle. Thus, it is shown as 100% in both Example 1 and Comparative Example 1, regardless of the actual capacity value.

As shown in FIG. 2, the battery cell using the negative electrode prepared according to Example 1 measured a capacity retention of about 70% after 100 charge/discharge cycles. However, the battery cell prepared according to Comparative Example measured a remarkably deteriorated capacity at about 30 cycles, and measured a capacity retention of less than 20% at about 80 cycles.

The negative active materials for rechargeable lithium batteries according to the present invention may provide rechargeable lithium batteries having improved capacities and cycle-life characteristics.

While this invention has been described in connection with certain exemplary embodiments, it is understood by those of ordinary skill in the art that various modifications and changes may be made to the described embodiments without departing from the spirit and scope of the present invention, as defined in the appended claims.

What is claimed is:

1. A negative active material for a rechargeable lithium battery, comprising:
a compound represented by Formula 1 and having an average particle size ranging from about 50 nm to 30 μm:
Li₁₊ₓV_{1-x-y}M_{y}O_{2+z} Formula 1
wherein 0.01≦x≦0.5, 0<y≦0.3, −0.2≦z≦0.2, and M is selected from the group consisting of transition elements, alkali metals, alkaline earth metals, semi-metals, and combinations thereof.

2. The negative active material of claim 1, wherein M is selected from the group consisting of Fe, Al, Cr, Mo, Ti, W, Zr, Sr, Mn, and combinations thereof.

3. The negative active material of claim 1, wherein the negative active material has an average particle size ranging from 0.5 μm to 20 μm.

4. The negative active material of claim 1, wherein the negative active material has a ratio of (003) plane diffraction intensity to (104) plane diffraction intensity ranging from about 1:0.01 to about 1 when measured using a Cu K α X-ray.

5. The negative active material of claim 4, wherein the negative active material has a ratio of (003) plane diffraction intensity to (104) plane diffraction intensity ranging from about 1:0.1 to about 1 when measured using a Cu K α X-ray.

6. The negative active material of claim 1, wherein after five charge/discharge cycles performed at 0.5 C, a specific surface area of the negative active material increases to less than about 20 times a specific surface area before the five charge/discharge cycles.

7. The negative active material of claim 6, wherein the specific surface area increases to about 2 to about 20 times the specific surface area before the five charge/discharge cycles.

8. A negative active material for a rechargeable lithium battery, comprising:
a compound represented by Formula 1 and having a ratio of (003) plane diffraction intensity to (104) plane diffraction intensity ranging from about 1:0.01 to about 1 when measured using a Cu K α X-ray:
Li₁₊ₓV_{1-x-y}M_{y}O_{2+z} Formula 1
wherein 0.01≦x ≦0.5, 0<y≦0.3, −0.2≦z≦0.2, and M is selected from the group consisting of transition elements, alkali metals, alkaline earth metals, semi-metals, and combinations thereof.

9. The negative active material of claim 8, wherein the negative active material has a ratio of (003) plane diffraction intensity to (104) plane diffraction intensity ranging from about 1:0.1 to about 1 when measured using a Cu K α X-ray.

10. The negative active material of claim 8, wherein M is selected from the group consisting of Fe, Al, Cr, Mo, Ti, W, Zr, Sr, Mn, and combinations thereof.

11. The negative active material of claim 8, wherein after five charge/discharge cycles performed at 0.5 C, a specific surface area of the negative active material increases to less than about 20 times a specific surface area before the five charge/discharge cycles.

12. The negative active material of claim 11, wherein the specific surface area increases to about 2 to about 20 times the specific surface area before the five charge/discharge cycles.

13. A negative active material for a rechargeable lithium battery, comprising a compound represented by Formula 1:
Li₁₊ₓV_{1-x-y}M_{y}O_{2+z} Formula 1
wherein 0.01≦x≦0.5, 0<y≦0.3, −0.2≦z≦0.2, and M is selected from the group consisting of transition elements, alkali metals, alkaline earth metals, semi-metals, and combinations thereof, and wherein after five charge/discharge cycles performed at 0.5 C, a specific surface area of the negative active material increases to less than about 20 times a specific surface area before the five charge/discharge cycles.

14. The negative active material of claim 13, wherein the specific surface area increases to about 2 to about 20 times the specific surface area before the five charge/discharge cycles.

15. A method for manufacturing a negative active material for a rechargeable lithium battery represented by Formula 1, the method comprising:
mixing a lithium source material and a vanadium source material in a mixed solvent of an acid and water to prepare an intermediate product; and
drying or decomposing by heat the intermediate product:
Li₁₊ₓV_{1-x-y}M_{y}O_{2+z} Formula 1
wherein 0.01≦x≦0.5, 0<y≦0.3, −0.2≦z≦0.2, and M is selected from the group consisting of transition elements, alkali metals, alkaline earth metals, semi-metals, and combinations thereof.

16. The method of claim 15, further comprising:
calcinating the intermediate product after drying or decomposing by heat.

17. The method of claim 15, wherein the heat decomposition is performed at a temperature ranging from about 70 to about 400° C.

18. The method of claim 16, wherein the calcination is performed at a temperature ranging from about 700 to about 1300° C.

19. The method of claim 15, wherein the lithium source material comprises a compound soluble in acid and water.

20. The method of claim 19, wherein the lithium source material is selected from the group consisting of Li₂C₂O₄, LiOH, LiNO₃, Li₂SO₄, hydrates of LiOH, hydrates of LiNO₃, hydrates of Li₂SO₄, and combinations thereof.

21. The method of claim 15, wherein the vanadium source material comprises a water insoluble compound.

22. The method of claim 21, wherein the vanadium source material is selected from the group consisting of V₂O₃, V₂O₄, V₂O₅, NH₄VO₃, and combinations thereof.

23. The method of claim 15, wherein the acid comprises a weak acid having at least one carboxyl group.

24. The method of claim 23, wherein the acid is selected from the group consisting of carboxylic acid, oxalic acid, citric acid, and combinations thereof.

25. The method of claim 15, wherein the lithium source material and the vanadium source material are further mixed with a M source material, wherein M is selected from the group consisting of transition elements, alkali metals, alkaline earth metals, semi-metals, and combinations thereof.

26. A rechargeable lithium battery comprising:
a negative electrode comprising:
a negative active material comprising a compound represented by Formula 1 and having an average particle size ranging from about 50 nm to about 30 μm:
Li₁₊ₓV_{1-x-y}M_{y}O_{2+z} Formula 1
wherein 0.01≦x≦0.5, 0<y≦0.3, −0.2≦z≦0.2, and M is selected from the group consisting of transition elements, alkali metals, alkaline earth metals, semi-metals, and combinations thereof;
a positive electrode comprising a positive active material capable of reversibly intercalating and deintercalating lithium ions; and
an electrolyte.

27. The rechargeable lithium battery of claim 26, wherein M is selected from the group consisting of Fe, Al, Cr, Mo, Ti, W, Zr, Sr, Mn, and combinations thereof.

28. The rechargeable lithium battery of claim 26, wherein the negative active material has an average particle size ranging from about 0.5 μm to about 20 μm.

29. The rechargeable lithium battery of claim 26, wherein the negative active material has a ratio of (003) plane diffraction intensity to (104) plane diffraction intensity ranging from about 1:0.01 to about 1 when measured using a Cu K α X-ray.

30. The rechargeable lithium battery of claim 29, wherein the negative active material has a ratio of (003) plane diffraction intensity to (104) plane diffraction intensity ranging from about 1:0.1 to about 1 when measured using a Cu K α X-ray.

31. The rechargeable lithium battery of claim 26, wherein after five charge/discharge cycles performed at 0.5 C, a specific surface area of the negative active material increases to less than about 20 times a specific surface area before the five charge/discharge cycles.

32. The rechargeable lithium battery of claim 31, wherein the specific surface area increases to about 2 to about 20 times the specific surface area before the five charge/discharge cycles.

33. A rechargeable lithium battery comprising:
a negative electrode comprising:
a negative active material comprising a compound represented by Formula 1 and having a ratio of (003) plane diffraction intensity to (104) plane diffraction intensity ranging from about 1:0.01 to about 1 when measured using a Cu K α X-ray:
Li₁₊ₓV_{1-x-y}M_{y}O_{2+z} Formula 1
wherein 0.01≦x≦0.5, 0<y≦0.3, −0.2≦z≦0.2, and M is selected from the group consisting of transition elements, alkali metals, alkaline earth metals, semi-metals, and combinations thereof;
a positive electrode comprising a positive active material capable of reversibly intercalating and deintercalating lithium ions; and
an electrolyte.

34. The rechargeable lithium battery of claim 33, wherein the negative active material has a ratio of (003) plane diffraction intensity to (104) plane diffraction intensity ranging from about 1:0.1 to about 1 when measured using a Cu K α X-ray.

35. The rechargeable lithium battery of claim 34, wherein M is selected from the group consisting of Fe, Al, Cr, Mo, Ti, W, Zr, Sr, Mn, and combinations thereof.

36. The rechargeable lithium battery of claim 33, wherein after five charge/discharge cycles performed at 0.5 C, a specific surface area of the negative active material increases to less than about 20 times a specific surface area before the five charge/discharge cycles.

37. The rechargeable lithium battery of claim 36, wherein the specific surface area increases to about 2 to about 20 times the specific surface area before the five charge/discharge cycles.

38. A rechargeable lithium battery, comprising:
a negative electrode comprising:
a negative active material comprising a compound represented by Formula 1:
Li₁₊ₓV_{1-x-y}M_{y}O_{2+z} Formula 1
wherein 0.01≦x≦0.5, 0<y≦0.3, −0.2≦z≦0.2, and M is selected from the group consisting of transition elements, alkali metals, alkaline earth metals, semi-metals, and combinations thereof, and wherein after five charge/discharge cycles performed at 0.5 C, a specific surface area of the negative active material increases to less than about 20 times a specific surface area before the five charge/discharge cycles;
a positive electrode comprising a positive active material capable of reversibly intercalating and deintercalating lithium ions; and
an electrolyte.

39. The rechargeable lithium battery of claim 38, wherein the specific surface area increases to about 2 to about 20 times the specific surface area before the five charge/discharge cycles.
